(19) United States
(12) Patent Application Publication
(10) Pub. No.: US 2002/0179638 A1
(43) Pub. Date: Dec. 5, 2002

(54) Anti-dripping spout configuration for liquid dispensers

(76) Inventor: Paul Huan Song, Alhambra, CA (US)

Correspondence Address: Paul Huan Song, 1229 S. Electric Ave., Alhambra, CA, 91803, US

(21) Appl. No.: 10/163,941

(22) Filed: Jun. 7, 2002

Related U.S. Application Data
(63) Continuation of application No. 09/704,247, filed on Nov. 2, 2000, now abandoned.

(51) Int. Cl. B67D 5/60; B67D 5/64

(52) U.S. Cl. 222/130; 222/192

(57) ABSTRACT

This invention provides proper design of spout mouth opening. The edge wall of spout mouth opening is made sloped inwardly/downwardly. With such configuration of spout mouth opening, gravitational force will help prevent liquid from spreading over the tip, side or base edge wall of the spout mouth, and hence prevent dripping in the following two situations:

a. When liquid is being poured out through the spout.

b. when pouring is finished, the dispenser together with spout is quickly turned upward from tilted position back to normal horizontal position.

REFERENCES CITED
US Patent Documents

| | | | |
|---|---|---|---|
| 1,512,964 | 10/1924 | Willis | 222/571 |
| 1,663,317 | 3/1928 | Richheimer | 222/571 |
| 2,732,108 | 1/1956 | Haddad | 222/564 |
| 4,061,255 | 12/1977 | Davies | 222/566 |

### BACKGROUND OF THE INVENTION

1.Field of the Invention

This invention relates to the field of spout and especially to anti-dripping spout.

2.Description of the Prior Art

The oldest and most popular configuration of spouts of liquid dispensers is as FIG. 1.

The opening of the spout mouth is facing upward.

Drip of liquid along the outside surface of spout often happens in one or both of these two situations:

a. When a dispenser with thicker spout mouth wall is held tilted toward a container or a target spot for pouring liquid out.

b. At the instant when the pouring of liquid is finished and the tilted dispenser together with spout is quickly turned upward back to normal horizontal position.

The process of pouring liquid out of a dispenser through the spout is as follows,

The dispenser together with spout is held tilted toward a receptacle, such as a container or a target spot, liquid in the dispenser will flow through the spout into the receptacle.

When enough liquid has been poured out, the dispenser together with spout is quickly turned upward from the tilted position to a normal horizontal position, causing the liquid flow to stop, then reverse its direction and go back into the dispenser.

For spout of the most popular configuration, at the instant when the pouring is finished and the dispenser together with spout is quickly turned upward, causing the liquid flow to stop and reverse its direction, due to adhesion effect and gravitational force, some liquid at the mouth portion of spout may spread over the tip edge, side edge or base edge of mouth opening, stick onto outside surface of the spout, and drip down, as in FIG. 2A.

In case that the wall at the mouth portion is rather thick, which is often true for dispensers made of pottery, porcelain or other thicker material, even during liquid pouring process, some liquid aided by adhesion effect and gravitational force, may spread over the mouth tip and drip along the outside surface of the spout, as in FIG. 2B.

Dripping from spouts of beverage dispensers often makes a mess and stains furnitures and clothes.

Dripping from spouts of dispensers of other liquids, may cause contamination, even hazard.

In the past years, there had been some designs with endeavor to solve such drip problem.

These designs generally have spout mouth openings facing downward, with varieties of spout mouth configuration.

These designs, while improving anti-dripping function, may be in rather complicated configuration, or may just offer limited improvement if key design details of spout mouth opening have not been taken care of.

### SUMMARY OF THE INVENTION

The present invention relates to configuration of anti-dripping spout of liquid dispensers, such as tea pot, coffee pot and other liquid dispensers.

The spout mouth opening is facing downward instead of facing upward as in the most popular spout configurations. The edge wall of spout mouth is made sloped inwardly/downwardly.

With configuration of spout mouth opening in accordance with the present invention, gravitational force not only won't aid, but will prevent liquid from spreading over the tip, side or base edge of spout mouth opening, sticking onto outside surface of spout and dripping.

Since liquid's spreading over the tip or edges of spout mouth opening is the only cause that makes liquid drip from outside surface of spout, the present invention will provide spouts with anti-dripping function that had been long sought for in related industries.

Declination angle between the longitudinal axis of spout at mouth portion and horizontal plane, does affect spout's anti-dripping function. Due attention must be paid to this factor in designing the spout of a new model of liquid dispenser.

### DETAILED DESCRIPTION OF THE INVENTION

This invention relates to anti-dripping spout mouth opening of liquid dispensers, refer to FIG. 3.

This invention is a particular configuration of spout mouth opening. The tip, side and base edge wall of the mouth opening are made sloped inwardly/downwardly. This means that the central axis of spout mouth opening is at an angle with the longitudinal axis of spout at mouth portion, as in FIGS. 5A/5B.

Such configuration prevents drip down from the outside surface of spout, either when liquid is being poured through it, or when pouring is finished and the dispenser together with spout is quickly turned upward back to normal horizontal possiton, causing the liquid flow to stop, reverse direction and go back into the dispenser.

Unlike the situation with spouts of the most popular configuration, gravitational force not only won't aid, but will prevent liquid from spreading over the tip, side or base edge of mouth opening and dripping.

When liquid is being poured out of a spout mouth opening designed according to this invention, due to gravitational force and momentum of the liquid flow via the spout, liquid will concentrate in the opening area biased toward the mouth tip and fall off, with a tendency of keeping away from base edge a-d-b as of FIGS. 6, 7, 8 & 9. During the pouriong process, liquid won't spread over the mouth tip and drip, as in FIG. 4A.

When pouring process is finished and the dispenser together with spout is quickly turned upward from tilted position to a normal horizontal position, at a spout mouth opening designed according to this invention, liquid flow will stop running out, reverse direction, and not spread over the side edge or base edge, but slide along the inwardly/downwardly sloped edge wall, on its way flowing through the interior of spout, back into the dispenser, as in FIG. 4B.

Liquid's spreading over the mouth tip, side or base edge wall, is the only cause that makes liquid to drip along outside surface of spout.

Geometric shape of the spout mouth opening does affect its anti-dripping function.

While spout mouth opening may be circular or in other omni-symmetrical shapes, the spout mouth opening is preferably in elongated shapes with its longer axis parallel to the longitudinal axis of the spout.

Mouth openings that are elongated in the direction parallel to longitudinal axis** of spout will help keep liquid flow away from base edge a-d-b, especially when the liquid is dense, or the wall at the mouth portion of spout is rather thick compared to spout's inner diameter.

Examples of such somewhat elongated shapes of mouth openings are Oval-FIG. 7, Rectangular-FIG. 8 and other somewhat elongated shapes designed with consideration of artistic patterns, or consideration of structural requirements, as exemplified in FIG. 9.

Declination angle** of spout, the angle between the longitudinal axis of spout and the horizontal plane, also affects spout's anti-dripping function.

The declination angle of spout of a product model of liquid dispenser, is a compromise among many things: the appearance of product, feasibility of manufacturing, anti-dripping function of spout and convenience to use the product.

Too small a declination angle of spout would deteriorate the anti-dripping function, but too large a declination angle of spout would be unacceptable from the stand point of product appearance or manufacturing process.

Usually the declination angle of spout is in a range of 50° to 80°. If artistic patterns or structural requirements dominate for different declination angle of spout, pre-production experiments are recommended.

Note**: Since a spout is not always straight and linear along its total length, longitudinal axis, as well as declination angle of spout, is taken near and along the mouth portion of the spout, because the mouth portion is essential in concern of structure and anti-dripping function of the spout.

### DESCRIPTION OF THE DRAWINGS

For a more complete understanding of the present invention, reference is made to the following description, taken in conjunction with the following related drawings:

FIG. 1 shows the side view of a liquid dispenser with spout of the most popular configuration.

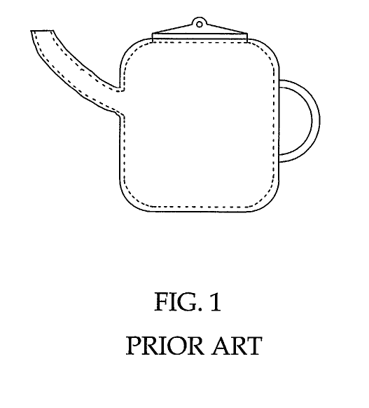

FIG. 2A shows a view of liquid dripping off a spout with most popular configurtion, when pouring process has been completed and liquid dispenser together with spout is quickly turned upward back to horizontal position. Some liquid remained at the mouth portion of spout, aided by adhesion effect and gravitational force, spreads over side or base edge onto the outside surface of spout and drips.

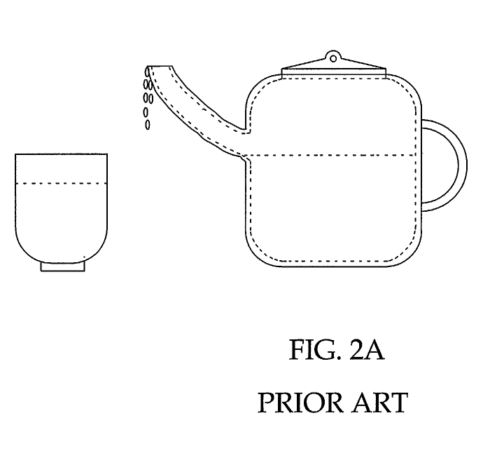

FIG. 2B shows a view during pouring process. A dispenser with spout of most popular configuration is tilted toward a cup. Most liquid through the spout falls into the cup, but some liquid, aided by adhesion effect and gravitational force, spreads over the spout mouth tip, sticks onto outside surface and drips.

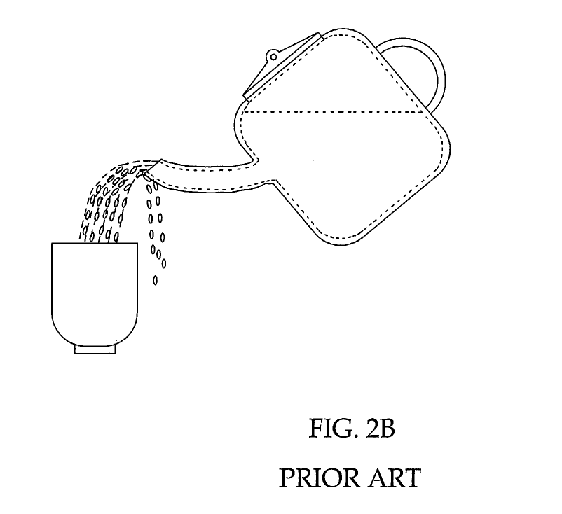

FIG. 3 shows a liquid dispenser with spout configuration of this invention.

FIG. 4A, Liquid is being poured out of a spout with configuration of this invention. Liquid falls off without spreading over mouth tip or any edge. Momentum of liquid flow and gravitational force help keep liquid flow away from base edge a-d-b of spout mouth opening, as of FIGS. 6, 7, 8 & 9. This reduces the chance that liquid would contact and spread over the base edge at the instant when dispenser together with spout is quickly turned upward back to normal horizontal position after pouring is finished.

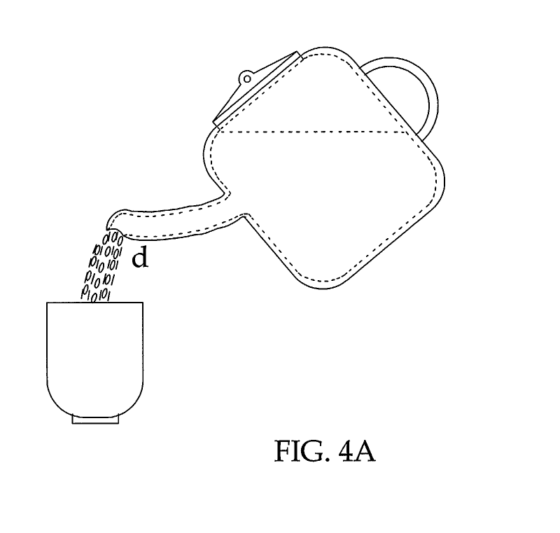

FIG. 4B, When pouring is finished, liquid dispenser with spout mouth configuration of this invention is quickly turned upward back to normal horizontal position, liquid remained in the mouth portion of spout will reverse flowing direction, stick onto the inside wall of spout and go back into dispenser.

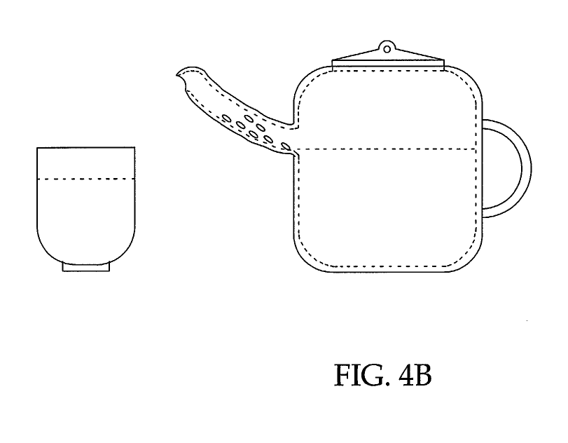

FIG. 5 shows a spout with mouth opening of this invention, as an enlarged section of spout indicated by circle 3 in FIG. 3.

FIG. 5A shows the cross sectional view of a preferred embodiment taken on plane A-A in FIG. 5. The tip, side and base edge wall are made sloped inwardly/downwardly at an angle θ. The downwardly sloping angle θ of base edge wall helps the liquid droplets remained at mouth portion slide down into the dispenser when pouring is finished and dispenser is quickly turned upward back to horizontal position.

FIG. 5B shows the cross sectional view of another preferred embodiment taken on plane A-A in FIG. 5. The sloping angle φ of the base edge wall is made even smaller than θ. Smaller φ helps the remained liquid droplets slide even more easily back into the dispenser.

FIG. 6, Example of circular openings of spout mouth.

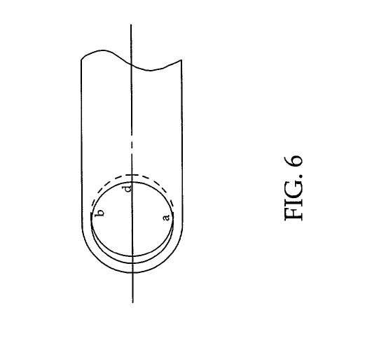

FIG. 7, Example of oval openings of spout mouth.

FIG. 8, Example of rectangular openings of spout mouth, preferably with smoothed corners.

FIG. 9, Example of other elongated openings of spout mouth, designed with consideration of artistic patterns, or with consideration of structural requirements.

### DESCRIPTION OF THE PREFERRED EMBODIMENTS

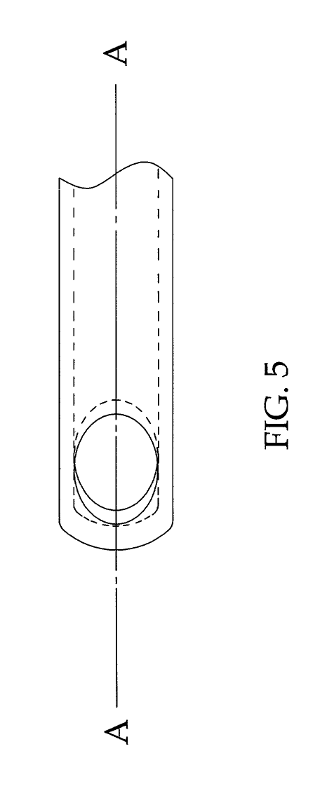

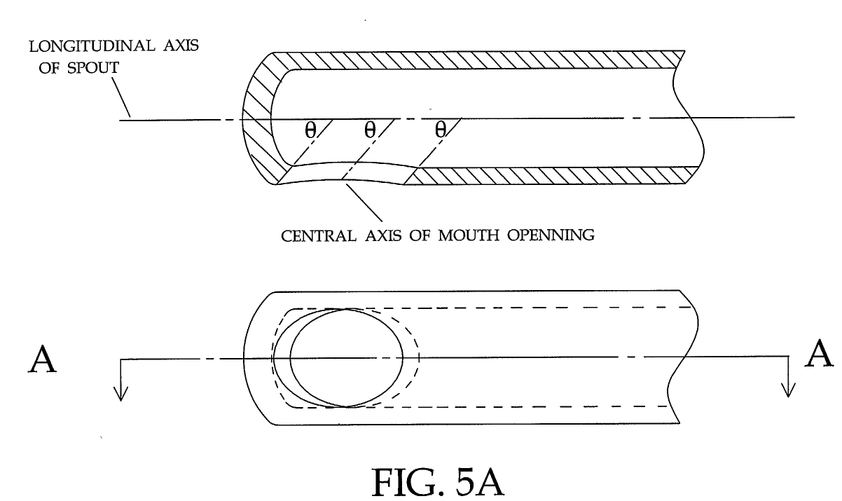

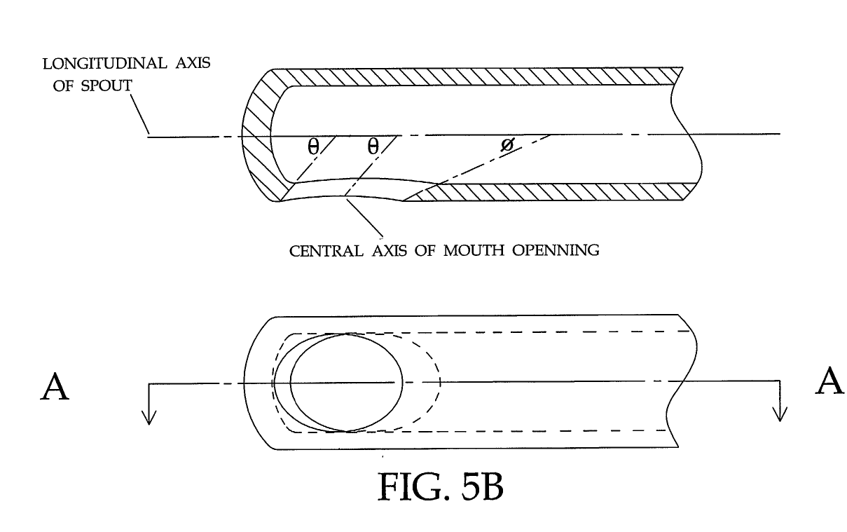

Refer to FIG. 5, FIG. 5A and FIG. 5B. Here FIG. 5A and FIG. 5B are cross-sectional views taken on plane A-A in FIG. 5.

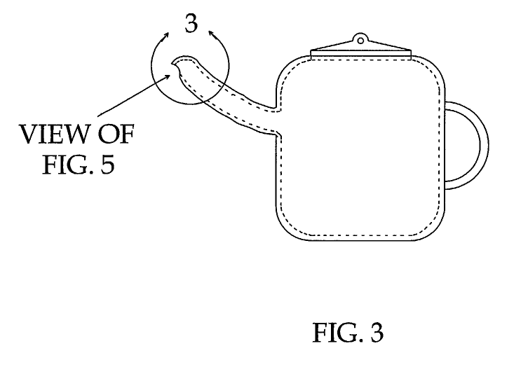

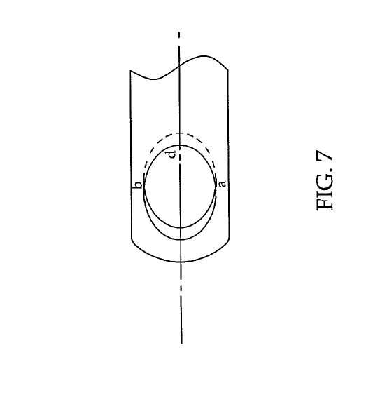

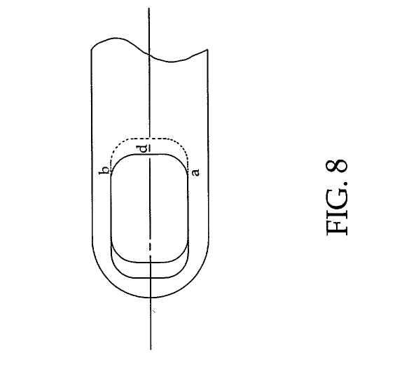

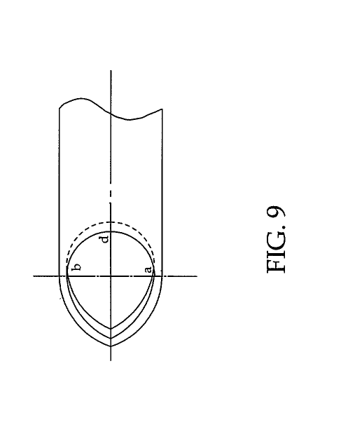

FIG. 5A shows the view of a preferred embodiment of this invention, as an enlarged section of spout indicated by circle 3 in FIG. 3. It has oval mouth opening elongated in the direction parallel to the longitudinal axis of spout. Oval mouth opening is used here as an example, althought it can be any other elongated shape as exemplified in FIG. 7, FIG. 8 & FIG. 9.

The edge wall of mouth opening is made sloped inwardly/downwardly. Viewed as a whole, the central axis of mouth opening is at a sloping angle θ with the longitudinal axis of spout.

Sharper sloping angle θ allows liquid droplets remained at the mouth portion slide more easily down into the dispenser at the instant when pouring is finished and dispenser together with spout is quickly turned upward back to horizontal position.

But sharper sloping angle will also make the base edge wall thinner and less strong. A compromise exists between structural strenghth and the required function. It depends on the material used to make the dispenser & spout. For thicker spout wall, such as those made of pottery or porcelain, θ may be, but not limited to, 45°to 70°. For those made of metal, plastic and other stronger materials, θ may be sharper. However, θ should not be made too sharp because it determines the angle at which liquid flow will fall off the tip of spout during pouring.

If sharper sloping angle of base edge wall is needed, another preferred embodiment is available.

FIG. 5B shows another preferred embodiment with a sharper (or smaller) sloping angle φ of base edge wall. φ is made smaller than θ intentionally, but sloping angle of tip or side wall will remain an unchanged θ. For thicker spout wall, such as those made of pottery or porcelain, φ may be, but not limited to, 25°to 40°.

For those made of metal, plastic or other stronger materials, φ may be smaller than 25°.

I claim:

1. The improvement of spout of liquid dispensers wherein the tip, side and base edge wall of the downward oriented spout mouth opening are made sloped inwardly/downwardly.

2. A spout as claimed in claim 1 wherein:
said spout mouth opening is oval in shape elongated in the direction parallel to lonitudinal axis of spout.

3. A spout as claimed in claim 1 wherein:
said spout mouth opening is retangular in shape elongated in the direction parallel to longitudinal axis of spout.

4. A spout as claimed in claim 1 wherein:
said spout mouth opening is in any other shape elongated in the direction parallel to longitudinal axis of spout.

5. A spout as claimed in claim 1 wherein:
said spout mouth opening is circular or in other symmetrical shape.
